(19) United States
(12) Patent Application Publication
(10) Pub. No.: US 2013/0191209 A1
(43) Pub. Date: Jul. 25, 2013

(54) REDUCING INVITATIONAL CONTENT SERVING EXPOSURE TO CAP LIMITED CAMPAIGNS

(71) Applicants: Mehul K. Sanghavi, Sunnyvale, CA (US); Michael Froimowitz Greenzeiger, Santa Clara, CA (US)

(72) Inventors: Mehul K. Sanghavi, Sunnyvale, CA (US); Michael Froimowitz Greenzeiger, Santa Clara, CA (US)

(73) Assignee: Apple Inc., Cupertino, CA (US)

(21) Appl. No.: 13/354,180

(22) Filed: Jan. 19, 2012

(51) Int. Cl. G06Q 30/02

(52) U.S. Cl. 705/14.48

(57) ABSTRACT

A content delivery system is provided managing a campaign using a content bundle identifying content blocks and rules for assembling the content blocks into items of invitational content. Based on the response of users to the invitational content, the invitational content to vary and evolve over time by modifying of the content bundle according to the user responses. An analysis of the responses can be performed to determine how the content bundle should be modified for users, user terminals, and other conditions. The content bundle can also specify a set of modification rules that can be used to automatically select how to modify the content bundle based on the user responses. In some cases, a content bundle can be associated with each unit of the content delivery system or each portal serviced by the content delivery system and managed separately.

### TECHNICAL FIELD

The present disclosure relates to invitational content and more specifically to reducing serving exposure during cap limited campaigns.

### INTRODUCTION

Traditionally, a single pricing model has been used to manage costs for display advertisement campaigns (including web-based or mobile advertisement campaigns). Generally, such models are impression based models (e.g., cost per a number of impressions, such as CPM) or performance based model (e.g., cost per click (CPC) or cost per action (CPA)). However, one concern with such models is the risk burden. For example, although CPM pricing guarantees that a publisher gets paid for each advertisement delivered, CPM pricing does not guarantee any results for the advertiser. Further, from an advertiser point of view, if the CPM campaign is successful, the advertiser is not recompensed for this success. In the case of CPC or CPA pricing, the publisher will be recompensed for successful conversions. However, if a large number of impressions are required to achieve this result, CPC or CPA does not recompense the publisher for the amount of impressions needed to achieve the conversions. In view of the foregoing, some advertisers and publishers have entered into hybrid pricing agreements to split the risks. One common arrangement is a combination of CPC and CPM.

Unfortunately, display advertising campaigns using a combination of CPM and CPC based pricing models can put a strain on the ad serving framework to keep cap-limited campaigns in check from getting overspent, i.e. to prevent budget overages. For example, consider a scenario where a campaign's daily budget cap is set to $100, a hybrid pricing model is provided with $10 CPM pricing and $2 CPC pricing, and the campaign is widely spread out over several publisher servers. In such a scenario, when the spending for day has hit $98 or $99, this will likely result in one or more of the publisher servers bringing in an additional click or two which can immediately result in an overage for the day.

### SUMMARY

Additional features and advantages of the disclosure will be set forth in the description which follows, and in part will be apparent from the description, or can be learned by practice of the herein disclosed principles. The features and advantages of the disclosure can be realized and obtained by means of the instruments and combinations particularly pointed out in the appended claims.

When the issues associated with hybrid pricing are examined, it is readily apparent that this is a sizable issue that needs to be solved for any publisher network that wants to use a hybrid pricing model. Collectively, the overages can be significant over the lifetime of the campaign, especially when concurrent campaigns running on the network are involved. Accordingly, the present technology provides a methodology for managing costs for hybrid pricing campaigns. Further, the present technology also addresses how to manage different publisher servers that may receive user traffic which performs differently. For example, traffic that performs differently based on geographical or other factors. In such cases, the present technology provides a methodology to enable publisher servers to be chosen preferentially based on performance of user traffic.

The present technology provides systems and methods for adjusting rules for delivering ad pricing invitational content that can limit or reduce the campaign exposure depending on several factors. Rules that can be adjusted in accordance with the present technology include delivery rules and fee rules. For example, the rules can be adjusted to allow some types of bonusing (i.e., free impressions) to prevent overages or switching to flat or other alternative pricing models when nearing the daily or other time-based caps for any campaign object (campaign, lines, ad orders or creatives). Delivery rules can be adjusted, for example, to provide reduced coverage to small pools of ad servers and to adjust inventory projections.

The systems and methods of the present technology can also be configured to specify at what rate campaign spending should be ramped down towards the end of the campaign, whether all or a subset of the servers used for the campaign should be ramped down equally or differently, including ceasing the serving of a particular ad campaign entirely on individual servers and pricing model preferences or targeting preferences of the network or individual advertiser.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary system configuration wherein electronic devices communicate via a network for purposes of exchanging content and other data;

FIG. 3A is a schematic illustration of how fees would be applied during a campaign in accordance with a conventional hybrid pricing scheme using CPM and CPC pricing.

FIG. 3B is a schematic illustration of a first general approach for how fees would be adjusted during a campaign with a hybrid pricing scheme using CPM and CPC pricing in accordance with the present technology;

FIG. 3C is a schematic illustration of a second general approach for how fees would adjusted during a campaign with a hybrid pricing scheme using CPM and CPC pricing in accordance with the present technology;

FIG. 3D is a schematic illustration of a third general approach for how fees would be adjusted during a campaign with a hybrid pricing scheme using CPM and CPC pricing in accordance with the present technology;

FIG. 4 illustrates an exemplary embodiment of a method for managing an electronic campaign in accordance with the present technology.

FIG. 5 illustrates another exemplary embodiment of a method for managing an electronic campaign in accordance with the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

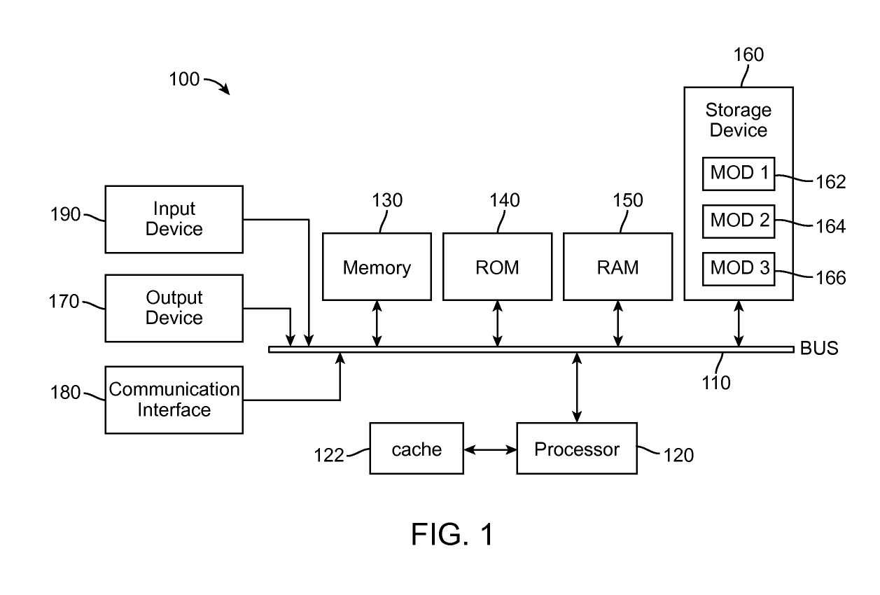

FIG. 1 illustrates an exemplary system 100 that includes a general-purpose computing device 100, including a processing unit (CPU or processor) 120 and a system bus 110 that couples various system components including the system memory 130, such as read only memory (ROM) 140, and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer-readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs a hard disk as storage device 160, it should be appreciated by those skilled in the art that other types of computer-readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166, which are modules configured to control the processor 120. These modules may be stored on the storage device 160 and loaded into RAM 150 or memory 130 at runtime or may be stored as would be known in the art in other computer-readable memory locations.

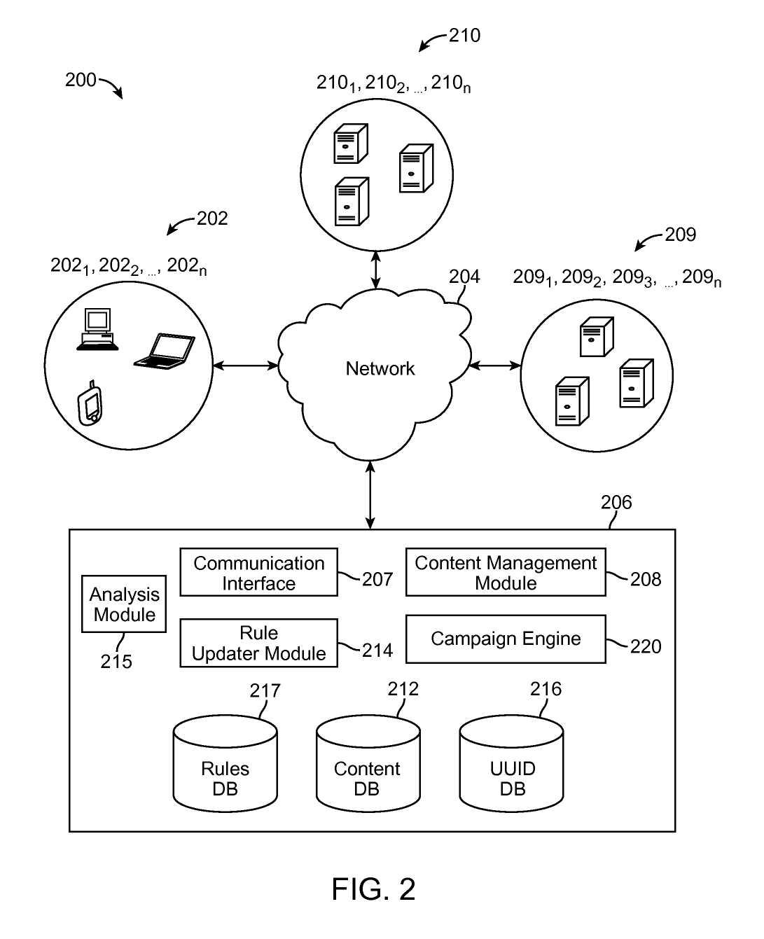

Having disclosed some components of a computing system, the disclosure now turns to FIG. 2, which illustrates an exemplary system configuration 200, wherein electronic devices communicate via a network for purposes of exchanging content and other data. The system can be configured for use on a network as that illustrated in FIG. 2. However, the present principles are applicable to a wide variety of network configurations that facilitate the intercommunication of electronic devices. For example, each of the components of system 200 in FIG. 2 can be implemented in a localized or distributed fashion in a network.

In system 200, invitational content is delivered to user terminals 202₁ . . . 202ₙ (collectively “202”) connected to a network 204 by direct and/or indirect communications with a content delivery system 206. In particular, the content delivery system 206 receives a request for a content package of electronic-invitational content, such as a web page, an application, a game, or media, etc., from one of user terminals 202. In the various embodiments, one or more types of invitational content can be combined in a content package. The user terminal 202 can be configured to render the received invitational content. This can include display or playing the invitational content appropriately depending on the form of the invitational content. For example, the invitational content can include text, graphics, audio, video, executable code or any combination thereof. Upon successfully rendering the delivered invitational content, the user terminal 202 can be configured to send a notification to the content delivery system 206. In some embodiments the notification can be a web beacon such as an embedded tracking pixel. In some embodiments, the invitational content can be associated with a product or can directly or indirectly advertise a product. In some embodiments, the content package can be configured to replace or update invitational content in a content package already delivered to the user terminal 202.

Further, the invitational content can be active invitational content. That is, invitational content that is designed to primarily elicit a pre-defined response from the user. For example, active invitational content can include one or more types of advertisements configured to be clicked upon, solicit information, or be converted by the user into a further action, such as a purchase or download of the advertised item. However, invitational content can also include passive invitational content. That is, invitational content that is designed to primarily inform the user. In some cases, passive invitational content can include information that can lead or direct users to active invitational content. Additionally, the invitational content can be dynamic invitational content. That is, invitational content that varies over time or that varies based on user interaction with the invitational content. However, the various embodiments are not limited in this regard and the invitational content can be static invitational content that does not vary over time or that varies based on user interaction. In the various embodiments, an invitational content in a content package can be static or dynamic and active or passive. Further, various types of invitational content can be combined in a same content package.

After receiving the request for invitational content, the content delivery system 206 selects the invitational content in response to the request and transmits the assembled invitational content to the requesting one of user terminals 202. In some embodiments, the server has preselected the invitational content before the request is received. Thereafter, the server assembles a content package of invitational content and causes the content package to be delivered to the user. The content delivery system can include a communications interface 207 to facilitate communications with the user terminals 202 and any other components familiar to those of ordinary skill in the art.

The content delivery system 206 includes a content management module 208 that facilitates generation of the assembled content package, which can include invitational content. Specifically, the content management module 208 can combine content from one or more primary content providers 209₁ . . . 209ₙ (collectively “209”) and content from one or more invitational content providers 210₁ . . . 210ₙ (collectively “210”) to generate the assembled content package for the user terminals 202. For example, in the case of a web page being delivered to a requesting one of user terminals 202, the content management module 208 can assemble a content package by requesting the data for the web page from one of the primary content providers 209 maintaining the web page. For the invitational content on the web page provided by the invitational content providers 210, the content management module 208 can request the appropriate data according to the arrangement between the primary and invitational content providers 209 and 210. In some embodiments, device 202 can directly request or already have access to primary content from primary content provider 209. In such embodiments, device 202 can further request invitational content from system 206. System 206 can identify and deliver invitational content appropriate for association with primary content. For example, primary content such as an application can already reside or be running of a device 202, and primary content can direct device 202 to request invitational content from system 206 to be associated with primary content on device 202.

As described above, content maintained by the content providers 209 and 210 can be combined according to a predefined arrangement, which can be embodied as a set of rules. In an arrangement where the content delivery system assembles the content package from multiple content providers, these rules can be stored in a rules database 217 in content delivery system 206 and content management module 208 can be configured to assemble the content package for user terminals 202 based on these rules. The rules can specify how to select content from secondary content providers 210 and the primary content providers 209 in response to a request from one of user terminals 202. For example, in the case of a web page maintained by one of primary providers 209 and including variable advertisement portions, the rules database 217 can specify rules for selecting one of the secondary providers 210. The rules can also specify how to select specific content from the selected one of secondary providers 210 to be combined with the content provided by one of primary providers 209. Once assembled, the assembled content package can be sent to a requesting one of user terminals 202. However, the content package is not limited to the content from content providers 209 and 210. Rather, the content package can include other data generated at the content delivery system 206.

Although primary and invitational content providers 209 and 210 are presented herein as separate entities, this is for illustrative purposes only. In some cases, the primary and invitational content providers 209 and 210 can be the same entity. Thus, a single entity can define and provide both the primary and the invitational content.

Although the content management module 208 can be configured to request that content be sent directly from content providers 209 and 210, a cached arrangement can also be used to improve performance of the content delivery system 206 and improve overall user experience. That is, the content delivery system 206 can include a content database 212 for locally storing/caching content maintained by content providers 209 and 210. The data in the content database 212 can be refreshed or updated on a regular basis to ensure that the content in the database 212 is up-to-date at the time of a request from a user terminal. However, in some cases, the content management module 208 can be configured to retrieve content directly from content providers 209 and 210 if the metadata associated with the data in content database 212 appears to be outdated or corrupted.

In the various embodiments, the content delivery system 206 can also include a unique user identifier (UUID) database 216 that can be used for managing sessions with the various user terminal devices 202. The UUID database 216 can be used with a variety of session management techniques. For example, the content delivery system 206 can implement an HTTP cookie or any other conventional session management method (e.g., IP address tracking, URL query strings, hidden form fields, window name tracking, authentication methods, and local shared objects) for user terminals 202 connected to content delivery system 206 via a substantially persistent network session. However, other methods can be used as well. For example, in the case of handheld communications devices, such as mobile phones, smart phones, tablets, or other types of user terminals connecting using multiple or non-persistent network sessions, multiple requests for content from such devices may be assigned to a same entry in the UUID database 216. The delivery system 206 can analyze the attributes of requesting devices to determine whether such requests can be attributed to the same user. Such attributes can include device or group-specific attributes.

In some embodiments, the content delivery system 206 can also include a campaign engine 220 which can be configured to fulfill campaigns for content providers 210 by managing inventory and pricing of invitational content delivered to user terminals 202. In the various embodiments, the campaign engine 220 engages in an inventory atom-based booking and atom-based pricing system. That is, the space for invitational content provided by primary content providers 210 is managed as an inventory or collection of atoms defining an inventory space or region in a k-dimensional space of atoms, where each of the k dimensions is associated with one of a plurality of traffic segment characteristics. In the various embodiments, the k dimensions can include both orthogonal and non-orthogonal dimensions. That is, some of the k dimensions can overlap or can be related in some aspect. For example, if separate dimensions are specified for city and a state including the city, these dimensions can be non-orthogonal.

In the various embodiments, each atom represents a portion of traffic associated with a specific set of values for the traffic segment characteristics in the k-dimensional space. For example, an atom can represent a fixed number of impressions for a particular segment. The inventory space will consist of one or more portions of the k-dimensional space depending on the segment characteristics associated with the content space available from the primary content providers 209. Accordingly the content delivery system 206 can manage an electronic campaign for one or more secondary content provider 210 based on the one or more segment characteristics of interest to each of the secondary content providers 210. In the various embodiments, the segment characteristics can include demographic characteristics, channel characteristics, spatial-temporal characteristics, behavioral characteristics, and demographic characteristics, to name a few. Channel characteristics can define the specific delivery channel being used to deliver a content package. For example, channel characteristics can include a type of electronic content, a type of device or user terminal, a carrier or network provider, or any other characteristic that defines a specific delivery channel for the content. Spatial-temporal characteristics can define a location, a date, a time, or any other characteristic that defines a geographic location and/or a time for delivery of the content. Demographic characteristics can define characteristics of the users targeted by the content or associated with the content. For example, demographic characteristics can include age, income, and ethnicity, but can also include other demographic characteristics such as gender, occupation, or any other user characteristics. Behavioral characteristics can define user behaviors for one or more different types of content, separately or in combination with any other contextual characteristics. That is, different behavioral characteristics may be associated with different channel, demographic, or spatial temporal characteristics. For example, users may be associated with higher conversion or response rates for some types of delivery channels.

In addition to allowing invitational content providers to arrange to have their invitational content delivered by the content delivery system 206 based on meeting a targeting criteria, fees are to be applied based on a hybrid pricing scheme. As used herein with respect to pricing schemes, cost models, fee arrangements and the like, the term “hybrid” indicates that an invitational content provider has arranged to be charged fees for a campaign based on two or more criterion or conditions. Each condition can be delivery- or impression-based, action- or performance-based, or a combination of both. Further, the rules can be applied separately or alternatively. That is, if delivery of invitation content results in meeting two separate conditions, the appropriate fee can be applied for each condition that is met. Alternatively, rules can be provided so that when multiple conditions are met, only one fee is applied.

The rules for applying fees can also be stored in rules database 217. However, the various embodiments are not limited in this regard and such rules can alternatively be stored in a separate database in other embodiments.

A delivery- or impression-based condition in the hybrid pricing scheme specifies that a invitational content provider is charged a set price for delivery of invitational content or eliciting a user response of viewing the invitational content. Such events can be measured as invitational content impressions. In the case of eliciting a user response of viewing the invitational content, an impression can be counted as every time an item of invitational content is displayed or viewed at the user terminal 202 for at least a predetermined amount of time. For example, if the invitational content is a banner advertisement, an impression can be counted if the banner advertisement is displayed on a user terminal 202 for 3 seconds. However, the various embodiments are not limited in this regard and the predetermined time can vary. In some embodiments, the time can vary according to the invitational content. For example, the invitational content can be a video and so an impression can be counted upon completion of the video or a pre-defined portion thereof.

An action- or performance-based condition in the hybrid pricing scheme specifies that a content provided is charged a set price, after delivery of the invitational content, for eliciting a user response to invitational content other than the viewing of the invitational content. For example, a campaign can charge for each conversion associated with delivered invitational content. A conversion can be counted in many ways, for example, in some embodiments a conversion can be counted when a user clicks on a banner advertisement and is forwarded to additional content. In some embodiments a conversion can be counted when a user purchases a product advertised by the invitational content.

Although the various embodiments will be described generally with respect to a hybrid pricing scheme including an impression-based criterion and an action-based criterion, this is solely for ease of illustration. Rather, the present disclosure contemplates that the present technology can be used with any combination of pricing schemes.

In addition to specifying targeting criteria and arranging a hybrid pricing scheme, a invitational content provider can also specify a budget for a campaign. In some cases, an invitational content provider can choose a maximum cost limit for a period of time. For example a campaign can be configured so that the cost of delivering the invitational content does not exceed $10,000 over a month. In other cases, the campaign can be configured to have a price limit over a time interval as well as another limit for a smaller time period. For example, a campaign can be allocated $10,000 over a month, but not to exceed $500 in any given day. Campaigns can also be configured to have a minimum amount to be spent per a certain time period. For example, a campaign can have a daily maximum budget of $1,000 per day as well as a minimum of $950 per day. These examples are not meant to be limiting and budgeting for campaigns can be configured in any number of ways known in the art.

The campaign engine 220 can be arranged to manage the delivery of the invitational content based on the parameters (i.e., targeting, pricing, and budget) of the campaign. For example, if a invitational content provider has arranged a maximum limit of $1,000 per day, the campaign engine 220 can monitor the number of impressions and conversions, and upon the limit being reached, no longer deliver the item of invitational content. Ensuring that the maximum limit is not exceeded can be important because in some cases the agreement with the invitational content provider may specify that the invitational content provider is not liable to pay more than the maximum limit per day and so any impression or conversion above the limit would be free of charge to the invitational content provider.

In addition to the above-mentioned components, the content delivery system 206 can further include an analysis module 215 for evaluating the performance of a campaign. The analysis can be performed in various ways and can provide various types of results. For example, the analysis module 215 can generate metrics for the campaign, provide a comparison of the campaign to specific criteria, generate values indicating that one or more conditions or criterion have been met, or any combinations thereof.

These exemplary analysis methods are provided solely for illustrative purposes and any other methods can be used without limitation. The results of the analysis can be communicated to an invitational content provider associated with a campaign, components within content delivery system 206, or any combination thereof.

The analysis module 215 can collect the data for evaluating a campaign from various sources. For example, the content delivery system 206 can be configured to maintain, as part of analysis module 215 or elsewhere, a journal of user responses to particular content blocks. The data for the diary can be obtained from various sources. For example, the content delivery system 206 can directly monitor responses to the invitational content it generates and update the diary accordingly. In another example, the content delivery system 206 can query the invitational content provider (such as content provider 210) to obtain information regarding responses to the invitational content and update the diary accordingly. In still another example, a user terminal 202 could be configured to archive responses locally and provide the results to the content delivery system 206 at a later time. Thereafter, the content delivery system 206 can update the diary accordingly.

When the content delivery system 206 system, via analysis module 215, can discern a user's previous responses and implied behavioral information, this data can be used by the content delivery system 206 to divert traffic in effect various policies during cap limited campaigns. One exemplary policy is to utilize the data to divert traffic to users who have ‘lesser’ propensity to response to delivered invitational content. This can be used to reduce the click rate effect, but maintaining the delivery goals against the impression counts. Alternatively, another exemplary policy is to utilize the same data to speed up the spending of the budget during specific time periods, thus offering the content delivery system 206 a means to even out impression-based spending, if campaign switches to CPM model later. For example data can be used to speed up the spend during the early part of the hour to even out impression based spend if the campaign switches to CPM model in the later part of the hour.

As described above, one aspect of the present technology is the gathering and use of data available from various sources to improve the delivery of advertisements or any other content that may be of interest to users. The present disclosure contemplates that in some instances, this gathered data may include personal information data that uniquely identifies or can be used to contact or locate a specific person. Such personal information data can include demographic data, location-based data, telephone numbers, email addresses, social media IDs such as TWITTER IDs, home addresses, or any other identifying information.

The present disclosure recognizes that the use of such personal information data in the present technology can be used to the benefit of users. For example, the personal information data can be used to better understand user behavior, facilitate and measure the effectiveness of advertisements, applications, and delivered content. Accordingly, use of such personal information data enables calculated control of the delivered content. For example, the system can reduce the number of times a user receives a given advertisement or other content and can thereby select and deliver content that is more meaningful to users. Such changes in system behavior improve the user experience. Further, other uses for personal information data that benefit the user are also contemplated by the present disclosure.

The present disclosure further contemplates that the entities responsible for the collection, analysis, disclosure, transfer, storage, or other use of such personal information data should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after the informed consent of the users. Additionally, such entities would take any needed steps for safeguarding and securing access to such personal information data and ensuring that others with access to the personal information data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for advertisement delivery services. In yet another example, users can configure their devices or user terminals to prevent storage or use of cookies and other mechanisms from which personal information data can be discerned. The present disclosure also contemplates that other methods or technologies may exist for blocking access to their personal information data.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

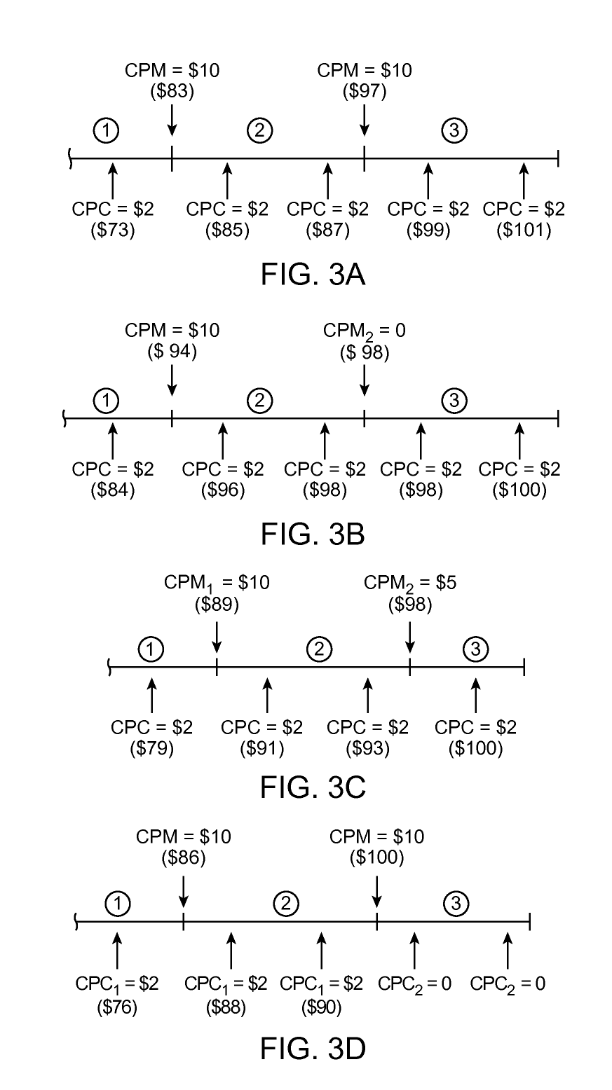

As noted above, one significant issue in the management of hybrid campaigns is the how to reduce the occurrence of overages (and shortfalls as well). That is, because the hybrid pricing scheme will rely on the occurrence of different conditions to apply different fees, there is a strong possibility that at one point one or more fees will result in an overage. This is illustrated with respect to FIG. 3A.

FIG. 3A is a schematic illustration of how fees would be applied during a campaign in accordance with a conventional hybrid pricing scheme using CPM and CPC pricing. For the example in FIG. 3A, the hybrid pricing scheme is configured for using a CPM pricing scheme (fee of $10 for the delivery of n items of invitational content), for using a CPC pricing scheme (fee of $2 for each click), and to utilize a total budget of $100. Additionally, for purposes of illustration and ease of explanation, the CPM pricing scheme is configured to apply delivery fees in advance.

As shown in FIG. 3A, after prepaying for block 1 of items of invitational content and one click occurs, the CPM and CPC costs will result in total costs of the campaign to have accumulated to $73. Thereafter, the content delivery system commits to delivery of block 2 of items of invitation content and the $10 CPM fee is applied, increasing total costs to $83. As shown in FIG. 3A, two clicks result from this block, and two $2 CPC fees are applied, increasing total costs to $87. Thereafter, the content delivery system commits to delivery of block 3 of items of invitation content and the $10 CPM fee is again applied, increasing total costs to $97. At this point, a first click occurs and a $2 CPC fee is applied increasing the total cost to $99. At this point, if any further clicks occur, an overage would occur. For example, as shown in FIG. 3A, applying an additional click results in another $2 CPC being applied, increasing costs to $101, resulting in an overage. The fees above are provided for illustrative purposes only. In the case of an actual campaign, the amount of overage can be significantly more, especially when the campaign is spread out over several servers.

One possible solution to this overage problem would have been to terminate the campaign before the last CPM fee was applied. However, this solution is disadvantageous for several reasons. First, this can result in a significant amount of budget going unused, resulting loss of revenue for the content delivery system. Second, the premature termination of the campaign would also result in a loss of opportunities for the invitational content provider. Accordingly, the present technology provides for adjusting the end of the campaign to minimize the amount of overage or shortfall. Some general approaches are illustrated with respect to FIGS. 3B, 3C, and 3D.

A first general approach, as described with respect to FIG. 3B, is to maintain substantially the same delivery rules, but adjust the fee rules to allow bonusing (i.e., free delivery of impressions) when only a small portion of the budget remains. That is, essentially switching from the hybrid pricing scheme (CPM/CPC) to an action-based pricing scheme (CPC only). As shown in FIG. 3B, after prepaying for block 1 of items of invitational content and one click occurs, the CPM and CPC costs will result in total costs of the campaign to have accumulated to $84. Thereafter, the content delivery system commits to delivery of block 2 of items of invitation content and the $10 CPM fee is applied, increasing total costs to $94. Two clicks result from this block, and two $2 CPC fees are applied, increasing total costs to $98. Thereafter, the content delivery system commits to delivery of block 3 of items of invitation content. However, the content delivery system, recognizing that the budget is close to being met, can be configured to apply an alternate CPM fee or switch to a CPC-only scheme. For example, as shown in FIG. 3B, a $0 CPM fee is now applied. Thus, after committing to block 3, the total costs remain at $98. In other words, the additional items are bonuses to the invitational content provider (i.e., free) and the content delivery system will instead rely on clicks for revenue. Accordingly, even if two clicks occur in the last block the budget is met, unlike the scenario in FIG. 3A. Thus even though the content delivery system gives up some revenue for the bonusing, it will still collect fees if the campaign remains successful.

Further, in some embodiments, rather than committing to delivering the entire block 3 on a bonused basis, the content delivery system can be configured for, to deliver a fraction of a normal block on a bonused basis. That is, items can be delivered on a bonused basis until sufficient clicks occur to substantially meet the budget. Thereafter the campaign can be terminated. Thus, total number of bonused items can be limited, reducing costs and risks at the content delivery system, while still meeting the budget.

A second general approach, as described with respect to FIG. 3C, is to keep substantially the same fee rules, but alter the delivery rules or commitments. As shown in FIG. 3C, after prepaying for block 1 of items of invitational content and one click occurs, the CPM and CPC costs will result in total costs of the campaign to have accumulated to $79. Thereafter, the content delivery system commits to delivery of block 2 of items of invitation content and the $10 CPM fee is applied, increasing total costs to $89. Two clicks result from this block, and two $2 CPC fees are applied, increasing total costs to $93. Thereafter, the content delivery system commits to delivery of block 3 of items of invitation content. However, the content delivery system, recognizing that the budget is close to being met, can be configured to limit the number of items of invitational content delivered in order to meet the budget. For example, the content delivery system can be configured to project a number of clicks likely to result for different numbers of items and select the number of items that would result in meeting the budget. For example, if it is estimated that for n items of content in a regular sized block, 2 clicks would occur, thus the cost of a block would be $14. In the case of FIG. 3C, where only $7 is left in the budget, the number of items delivered (the associated fees) can then be scaled accordingly, e.g., by ½. Thus, the content delivery system would instead commit to delivery of half of the items as in previous blocks and a scaled CMP fee (CPM2) of $5 would be applied instead, increasing total costs to $98. Thereafter, if the one projected click occurs, the CPC fee of $2 is applied and the budget is met.

In a third general approach, as described with respect to FIG. 3D, is to adjust the campaign to a CPM model to prevent click overages. For example, shown in FIG. D, after prepaying for block 1 of items of invitational content and one click occurs, the CPM and CPC costs will result in total costs of the campaign to have accumulated to $76. Thereafter, the content delivery system commits to delivery of block 2 of items of invitation content and the $10 CPM fee is applied, increasing total costs to $86. Two clicks result from this block, and two $2 CPC fees are applied, increasing total costs to $90. Thereafter, the content delivery system commits to delivery of block 3 of items of invitation content. However, the content delivery system, recognizing that the budget is close to being met, can be configured to switch to a CPM model in order to meet the budget and prevent overages. Thus, the content delivery system is configured to select the number of items that would result in meeting the budget.

To reduce the disadvantages to the content delivery system with respect to CPM models, in some cases the agreement between the parties can state that in such instances, a higher CPM pricing is applied. However, the present technology is not limited in this regard and the CPM pricing can be adjusted upward or downward in the various embodiments. Further, while overage prevention is key, it is also important to meet the spend goal. Thus increasing CPM for the final few deliveries can be implemented to ensure that the budget for the campaign is met.

The present disclosure also contemplates that the last block delivered in FIGS. 3B-3D can also be adjusted on a time basis. That is, the reduced number of items can be delivered over the same period of time a larger number of items would be delivered. In other words, the campaign can be slowed down.

An advantage of the methods of FIGS. 3B-3D is that even if the click does not occur and a shortfall does occur, the total cost will be close to the desired budget target. Further, if extra clicks occur, the overage would be minimized since the reduction in items delivered reduces the opportunity for such extra clicks to occur.

In some embodiments, the methods of FIGS. 3B-3D can be combined. For example, when the last click in FIG. 3C does not occur the content delivery system can be configured to deliver bonus items, as in FIG. 3B, until the last click occurs.

In the various embodiments, the content delivery system can be configured to include means for updating the rules. For example, as shown in FIG. 2, content delivery system 206 can include a rule updating module 214 for updating the rules in rules database 217. However, the various embodiments are not limited in this regard and the rule updater module 214 can be located in components separate from content delivery system 206. In still other embodiments, a single rule updater module can be provided to adjust rules across multiple servers. Alternatively, rule updater module 214 can be implemented in a distributed manner to apply changes in rules across multiple servers in a concerted way.

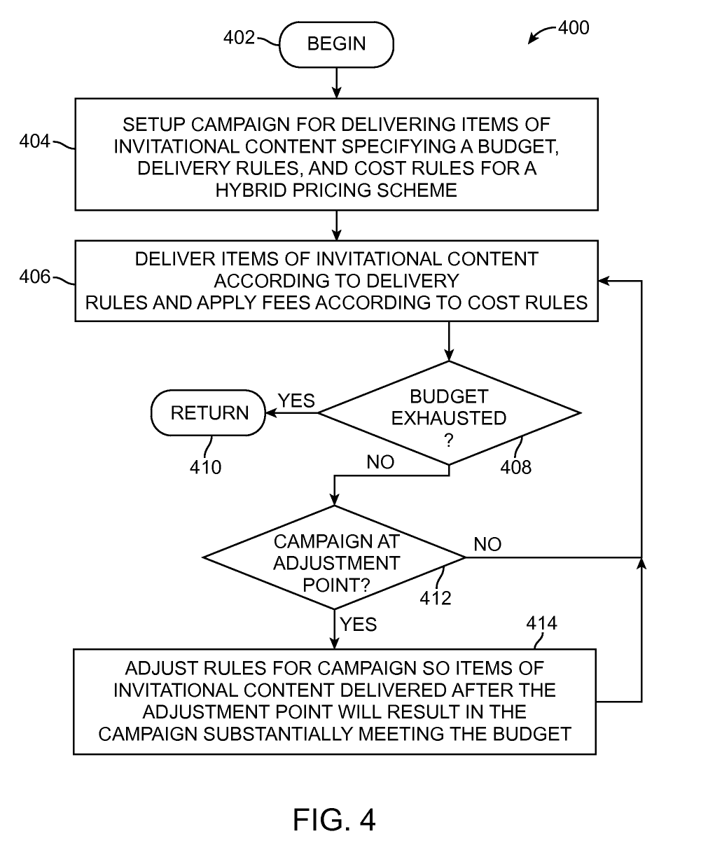

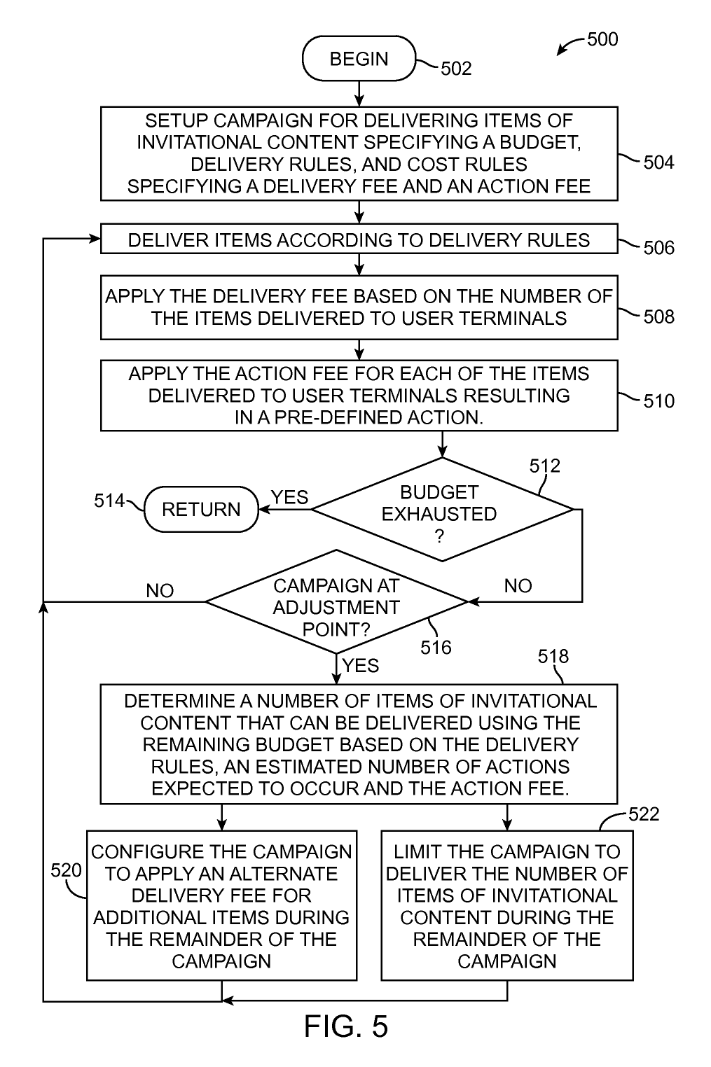

Operation of the content delivery system 206 to carry out the methods described above is discussed below in greater detail below with respect to FIGS. 4 and 5.

FIG. 4 illustrates an exemplary embodiment of a method 400 for managing an electronic campaign in accordance with the present technology. Method 400 begins at block 402 and continues on to block 404. At block 404, a campaign is setup or established at content delivery system 206. That is, a budget is specified for the campaign. Further, delivery rules and cost or fee rules can be stored for the campaign in rules database 217.

After the campaign is established at block 404, delivery of items of invitational content can begin at block 406. Block 406 can include configuring the campaign engine 220 to instruct the content management module 208 to assemble the items of invitational content to be delivered and configuring the communications interface 207 to deliver the items to user terminals 202. Additionally, block 406 can encompass the campaign engine 220 applying fees according to the fee rules in rules database 217. In the case where the hybrid pricing scheme includes action-based pricing, block 406 can also include collecting information regarding user responses at user terminals 202 to determine which fees are applicable.

In conjunction with operations at block 406, the method 400 can also include checking whether budget has been exhausted at block 408. For example, prior to delivering each item or a group of items of invitational content, the campaign engine 220 can first determine at block 408 whether any budget remains. If the budget is determined to have been exhausted at block 408, the method can resume previous processing at block 410, including repeating method 400. The present disclosure also contemplates that other termination conditions could apply and cause method 400 to proceed to block 410 during operation of method 400. The determination can be made, for example, by analysis module 215. However, the present technology is not limited in this regard.

If it is determined at block 408 that some amount of budget still remains, the method can determine whether the campaign is at an adjustment point at block 412. That is, has the campaign reached a point at which the hybrid pricing scheme needs to be adjusted to minimize overage of shortfall with respect to the budget. In the various embodiments, an adjustment point can be defined in several ways. Further, in case of a campaign deployed over multiple servers, the determination of an adjustment point can be made on a global basis, a per server basis, or a combination of both.

In some embodiments, the adjustment point can be a predefined point in the campaign. For example, the adjustment point can be defined as when the campaign is in a predefined state, such as at a certain budget level or at a certain time. Further, the adjustment point can be associated with an interval. For example, an adjustment point can be determined to have occurred if a particular number of items have been delivered or if a particular length of time has elapsed. These are but a few examples. In the various embodiments, any other type of pre-defined conditions can be specified to define an adjustment point.

In some embodiments, the conditions for the adjustment point can be dynamically determined. That is, is the state of the campaign can be evaluated and a projection can be made to determine whether or not proceeding with the current delivery and fee rules is likely to result in an overage. For example, the past results of the campaign can be evaluated and a projection as to the number of impressions and clicks likely to occur in the remaining time for the campaign can be projected. These results can then be compared to some criteria to determine whether or not an adjustment point has been reached.

The present disclosure also contemplates that there may be several adjustment points utilized. Such a configuration can be used to provide additional control when winding down a campaign. Also, by looking at several adjustment points, it is possible to readjust the campaign if a previous adjustment was incorrect.

Referring back to FIG. 4, if an adjustment point has not been reached at block 412, the method 400 can return to block 406 and continue processing. However, if an adjustment point has been reached at block 412, adjustment of the rules for the campaign can proceed at block 414 to perform rule adjustments. In particular, rule adjustments can be provided so that the campaign will result in the campaign substantially meeting the budget. As noted above, the rule adjustments can be performed by rule updater module 214 on a local or global basis.

In the various embodiments, the rules for the campaign can be adjusted in a variety of ways. Some of these methods have been described above with respect to FIGS. 3B and 3C. However, the present technology is not limited to description above for these methods.

In some embodiments, the rule adjustments to be used can be pre-defined. That is, a specific type of delivery or pricing rule adjustment can be associated with a particular adjustment point. For example, the pre-defined rules can explicitly state how to adjust CPM pricing or CPC pricing when an adjustment point is reached. These pre-defined rule adjustments can be establishing prior to implementation of the campaign and possibly even be part of the agreement with the invitational content provider. Further, in some embodiments, the invitational content provider can alter the pre-define rule adjustments. In some embodiments, the rules database 217 can be configured to store alternate rules such that when a particular adjustment point is reached, the content delivery system 206 can simply access and activate the alternate rules for the campaign. Such pre-defined rule adjustments can be used regardless of whether the adjustment point is pre-defined or determined dynamically.

In other embodiments, the rule adjustment can be determined dynamically or only be partially pre-defined. The amount and type of dynamic adjustments can be determined by content delivery system 206 using the analysis module 215 or the rule updater module 214. For example, if an adjustment point has been reached, the content delivery system 206 could determine how the delivery or pricing rules should be adjusted based on the remaining budget, past performance, projected future performance, other factors, or any combinations thereof. In the various embodiments, determination of the rule adjustments can be made once the adjustments have been determined, the rules in rules database 217 can be adjusted accordingly. Such dynamic rule adjustments can be used regardless of whether the adjustment point is pre-defined or determined dynamically.

In some embodiments, the rule adjustments can be provided on a global basis, a per server basis, or a combination of both. In particular, a per server basis provides additional advantages. For example, if it is determined that there are a number of high performing servers and a number of low performing servers, the delivery and pricing rules can be adjusted so that the campaign focuses delivery of invitational content at the high performing servers. That is, if the number of impressions being delivered by each of the servers was initially the same, the rule adjustment can allow for more impressions to be delivered by the high performing servers. Alternatively, bonusing could be applied at the lower performing servers. In some cases, the campaign could even be completely shifted to the high performing servers.

Referring back to FIG. 4, once the rules for the campaign have been adjusted at block 414, the method can return to block 406 to continue processing. Blocks 406, 408, 412, and 414 can then be repeated until the budget is exhausted block 408 or some other termination condition occurs.

A more detailed example of a method 500 for managing a hybrid CPM/CPC campaign is illustrated in FIG. 5. Method 500 begins at block 502 and proceeds to block 504. At block 504, a campaign is established with a hybrid pricing scheme with a budget, delivery rules, and cost rules specifying a delivery fee (CPM fee) and an action fee (CPC fee). Thereafter, the campaign is started in block 506 by delivering items of invitation content in accordance with the rules in block 504.

In combination with the delivery in block 506, fees are applied at blocks 508 and 510. At block 508, delivery fees are applied based on the number of items delivered. These fees can be applied prior to or after the items are delivered. Further, the fees can be applied individually (i.e., per item) or aggregately (i.e., per number of items). Additionally, the fee can vary depending on various factors, such as type and location for the item. At block 510, action fees are applied for each of the items delivered that result in a pre-defined action. As in block 508, the fees can be applied in block 510 individually (i.e., per item) or aggregately (i.e., per number of items). Additionally, the fee in block 510 can vary depending on various factors, such as type and location for the item and the type of pre-defined action that has occurred.

As delivery of items of invitational content and application of fees proceeds at blocks 506, 508, and 510, a determining of whether the budget has been exhausted (or whether any other termination conditions apply) can be determined at block 512 in a substantially similar manner as in block 408 in FIG. 4. Thus is if the budget has been exhausted, the method 500 proceeds to block 514 to resume previous processing. If the budget has not yet been exhausted, the method can proceed to block 516. At block 516, the method 500 can determine whether or not adjustment point has been reached in substantially similar manner as block 412 in FIG. 4. Thus is the adjustment point has not yet been reached, previous processing is resumed at block 506. If the adjustment point has been reached, the method 500 can proceed to block 518.

At block 518, a determination can be made as to how many items of invitational content can be delivered using the remaining budget based on the current delivery rules and fees, the projection of future performance for these items, and the action fee projected to be applied. For example, as previously described, the analysis module 215 can be configured to collect and analyze data to obtain such information. Thereafter, the method 518 can proceed to one of blocks 520 and 522.

At block 520, the campaign rules can be configured to provide the arrangement described above with respect to FIG. 3B. That is, to apply an alternate delivery fee for items for the remainder of the campaign. For example, as described above, such items could be bonused items that are delivered free of charge or to which a discounted fee is applied. The method 500 can then proceed to block 506 to continue the campaign.

At block 522, the campaign rules can be configured to limit the number of items of invitational content that are delivered during the remainder of the campaign. For example, as described above, a projection of the performance could be used to estimate how many more items need to be delivered to result in the campaign substantially meeting the budget.

In some embodiments, one of 520 and 522 can be used each and every time. However, in some case it can be useful to alternate between approaches. For example, near the end of the campaign it may be useful to limit the number of items delivered (i.e., use block 522). However, if the budget is not exhausted after such an adjustment, bonusing (i.e., block 520) can be used to attempt and collect the last remaining portion of the budget without significant overage. Accordingly, the present disclosure contemplates that block 518 can also include determining a preferred approach for the remainder of the campaign.

Further, alternating between approaches can also be useful when utilizing multiple servers. In such case, it can be useful to apply bonusing at one server while limiting the number of items delivered at other servers. In some cases, this can be necessary. For example, if the agreement for the invitational content provider guarantees a number of impressions at each server, bonusing and discounting among the different servers can be used to limit overages.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method, comprising:
implementing, at a content delivery system, a campaign to begin delivery of items of invitational content according to first delivery rules and for applying fees for the campaign according to first cost rules, the first costs rules specifying a hybrid pricing scheme for the items of invitational content; and
adjusting any of the first delivery rules and the first cost rules to yield second delivery rules and second cost rules at an adjustment point prior to the end of the campaign,
wherein the second delivery rules and the second cost rules are selected so that subsequent delivery of the items of invitational content will result in the campaign substantially meeting the budget.

2. The method of claim 1, wherein the adjusting further comprises:
obtaining a criteria for the adjustment point; and
initiating the adjusting when a state of the campaign meets the criteria.

3. The method of claim 2, wherein the criteria is any of at least one cost criteria and at least one delivery criteria.

4. The method of claim 3, wherein the criteria is a pre-defined.

5. The method of claim 3, wherein the obtaining further comprises calculating the criteria.

6. The method of claim 1, wherein the adjusting further comprises:
estimating a number of the items of invitational content that can be delivered after the adjustment point based on the first delivery rules and still substantially meet the budget based on the first cost rules; and
configuring the second delivery rules to allow only the number of the items of invitational content to be delivered during a remainder of the campaign.

7. The method of claim 1, wherein the adjusting further comprises:
estimating a number of the items of invitational content that can be delivered after the adjustment point and still substantially meet the budget based on the first cost rules; and
configuring the second cost rules to apply an alternate pricing for delivering an additional number of the items of invitational content if the budget is not substantially met after the delivery of the number of items of invitational content.

8. The method of claim 1, wherein the content delivery system implements the campaign using a plurality of segments and, wherein the adjusting comprises:
analyzing a progress of the campaign at each of the plurality of segments; and
selectively configuring the second delivery rules and the second cost rules for each of the plurality of segments.

9. A content delivery system, comprising:
a campaign management module for implementing a campaign to begin delivery of items of invitational content according to first delivery rules and for applying fees for the campaign according to first cost rules, the first costs rules specifying a hybrid pricing scheme for the items of invitational content; and
an updater module for adjusting any of the first delivery rules and the first cost rules to yield second delivery rules and second cost rules at an adjustment point prior to the end of the campaign,
wherein the second delivery rules and the second cost rules are selected so that subsequent delivery of the items of invitational content will result in the campaign substantially meeting the budget.

10. The system of claim 9, further comprising an analysis module configured for determining whether the campaign is at the adjustment point based on a current state of the campaign.

11. The system of claim 10, wherein the criteria is a pre-defined.

12. The system of claim 10, wherein the analysis module is further configured for calculating the criteria.

13. The system of claim 9, wherein the updater module is further configured for:
estimating a number of the items of invitational content that can be delivered after the adjustment point based on the first delivery rules and still substantially meet the budget based on the first cost rules; and
configuring the second delivery rules to allow only the number of the items of invitational content to be delivered during a remainder of the campaign.

14. The system of claim 9, wherein the updater module is further configured for:
estimating a number of the items of invitational content that can be delivered after the adjustment point and still substantially meet the budget based on the first cost rules; and
configuring the second cost rules to apply an alternate pricing for delivering an additional number of the items of invitational content if the budget is not substantially met after the delivery of the number of items of invitational content.

15. A non-transitory computer-readable medium, comprising instructions for:
implementing a campaign for delivering of items of invitational content to user terminals according to first delivery rules and for applying fees for the items of invitational content according to first cost rules, the first costs rules specifying rules for applying at least one delivery fee responsive to delivery of one or more of the items of invitational content to the user terminals and applying at least one action fee responsive to any delivered one of the items of invitational content resulting in one or more pre-defined actions occurring at one or more of the user terminals; and
adjusting any of the first delivery rules and the first cost rules to yield second delivery rules and second cost rules at an adjustment point prior to the end of the campaign,
wherein the second delivery rules and the second cost rules are selected so that subsequent delivery of the items of invitational content will result in the campaign substantially meeting the budget.

16. The non-transitory computer-readable medium of claim 15, wherein the adjusting further comprises:
obtaining a criteria for the adjustment point; and
initiating the adjusting when a state of the campaign meets the criteria.

17. The non-transitory computer-readable medium of claim 16, wherein the criteria is any of at least one cost criteria and at least one delivery criteria.

18. The non-transitory computer-readable medium of claim 17, wherein the criteria is a pre-defined.

19. The non-transitory computer-readable medium of claim 17, wherein the obtaining further comprises calculating the criteria.

20. The non-transitory computer-readable medium of claim 15, wherein the adjusting further comprises:
obtaining an estimate of a number of the items of invitational content that can be delivered after the adjustment point based on the first delivery rules and still substantially meet the budget based on the first cost rules and an estimate of a number of the pre-defined actions that will occur based on the estimate of the number of items of invitational content that can be delivered; and
configuring the second delivery rules to allow only the number of the items of invitational content to be delivered during a remainder of the campaign.

21. The non-transitory computer-readable medium of claim 15, wherein the adjusting further comprises:
obtaining an estimate of a number of the items of invitational content that can be delivered after the adjustment point based on the first delivery rules and still substantially meet the budget based on the first cost rules and an estimate of a number of the pre-defined actions that will occur based on the estimate of the number of items of invitational content that can be delivered; and
configuring the second cost rules to apply an alternate delivery fee for delivering an additional number of the items of invitational content if the budget is not substantially met after the delivery of the number of items of invitational content.

22. The non-transitory computer-readable medium of claim 21, wherein the alternate delivery fee is zero.

23. The non-transitory computer-readable medium of claim 15, wherein the content delivery system implements the campaign using a plurality of segments and, wherein the adjusting comprises:
analyzing a progress of the campaign at each of the plurality of segments; and
selectively configuring the second delivery rules and the second cost rules for each of the plurality of segments.

24. A method, comprising:
implementing, via a plurality of content delivery systems, a campaign for delivering of items of invitational content to user terminals according to delivery rules and for applying fees for the items of invitational content according to cost rules, the first cost rules specifying rules for applying at least one delivery fee responsive to delivery of one or more of the items of invitational content to the user terminals and applying at least one action fee responsive to any delivered one of the items of invitational content resulting in one or more pre-defined actions occurring at one or more of the user terminals;
at an adjustment point prior to the end of the campaign, obtaining an analysis of a performance of the campaign with respect to each of the plurality of content delivery systems; and
based on the analysis, selectively adjusting the delivery rules and the cost rules at each of the plurality of content delivery systems so that subsequent delivery of the items of invitational content will result in the campaign substantially meeting the budget.

25. The method of claim 24, wherein the adjusting comprises modifying the delivery rules for a portion of the plurality of content delivery systems to reduce a number of the items of invitational content delivered by the portion of the plurality of content delivery systems.

26. The method of claim 24, wherein the adjusting comprises modifying the cost rules for a portion of the plurality of content delivery systems to apply an alternate fee for at the items of invitational content delivered by the portion of the plurality of content delivery systems.

27. The method of claim 26, wherein the alternate fee is zero.
